(19) United States
(12) Patent Application Publication
(10) Pub. No.: US 2008/0019349 A1
(43) Pub. Date: Jan. 24, 2008

(54) Method and apparatus for allocating beacon slot in distributed wireless network

(75) Inventor: Se-hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/714,824

(22) Filed: Mar. 7, 2007

(30) Foreign Application Priority Data
Jul. 21, 2006 (KR) 10-2006-0068406

(51) Int. Cl. H04B 7/212

(52) U.S. Cl. 370/347

(57) ABSTRACT

A method and apparatus for efficiently using a super frame in a distributed wireless network are provided. In a beacon period of a super frame, a beacon slot of a hibernation planning device is moved to the front of the beacon period such that a beacon slot that cannot be changed in a beacon period is prevented from being positioned at the back of the beacon period. In this way, all beacon slots in a beacon period can be adjusted and thus the length of the entire beacon period can be shortened; the length of a data transmission period can be lengthened; and the super frame can be efficiently used.

### CROSS-REFERENCE TO RELATED PATENT APPLICATIONS

This application claims the benefit of Korean Patent Application No. 10-2006-0068406, filed on Jul. 21, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to a distributed wireless network for efficiently using a super frame in a distributed wireless network.

2. Description of the Related Art

Wireless personal area networks can be roughly characterized as centralized networks or distributed networks according to media access control methods. In centralized networks, one device performs the role of a coordinator which manages and adjusts the media access of all devices, while in distributed networks, all devices share the burden of managing the media access of devices. An example of a representative distributed network is an ultra wideband (UWB) network.

UWB communication technology is a wireless transmission technology capable of transmitting a large quantity of data, up to hundreds of Mbps, through a wide bandwidth frequency channel with low power consumption over a short distance.

In a UWB network, devices are allowed to exclusively use wireless media for a predetermined length of time by using a time division method. In this case, a super frame is used as a basic unit of time resource.

FIG. 1 is a diagram illustrating a structure of a super frame used in a distributed wireless network according to related technology.

As illustrated in FIG. 1, a super frame is composed of small periods referred to as media access slots (MASs). An entire super frame can be divided into a beacon period and a data period. The beacon period is assigned so that a plurality of network devices can transmit beacon frames containing their information, and the data period is assigned so that the devices can transmit data.

The beacon period is divided into a plurality of beacon slots. Each device transmits a beacon frame at its own slot, and thus all devices in the network can obtain information on each other. For reference, each beacon slot is composed of a plurality of MASs.

In general, a beacon period has a predetermined minimum length, but, depending on the situation, the period can be extended by a predetermined time, for example, a time corresponding to an “mMaxBPLength” value in multiband orthogonal frequency division multiplexing alliance media access control (MBOA-MAC). However, assuming that the length of the super frame is constant, if a beacon period is extended, it means a corresponding reduction in the data period. Accordingly, the length of the beacon period may be reduced as much as possible.

FIG. 2 is a diagram illustrating a method of shortening the length of a beacon period according to related technology.

As illustrated in FIG. 2, if an empty beacon slot in a preceding part of a beacon period is found, a device using a beacon slot in the beacon period can use the found empty beacon slot. That is, referring to FIG. 2, device 8 finds an empty beacon slot between the beacon slots of device 5 and device 9, and by changing the position of the beacon slot of device 8 from the next super frame onward, the entire beacon period can be shortened. However, in order for this to occur, device 8 should be in a state whereby it can change position of the beacon slot, that is, a “movable” state. Each device of a distributed network records in a beacon frame whether or not it is in a movable state, and broadcasts the beacon frame.

Devices using the MBOA-MAC can operate either in an active mode or in a hibernating mode. In the hibernating mode, a device does not transmit or receive a beacon frame, and thus the device becomes “immovable”. A device planning to enter into a hibernating mode declares for how many super frames the device will be in the hibernating mode, in advance, using a beacon frame.

FIG. 3 is a diagram illustrating a structure of a beacon frame used in the MBOA-MAC according to related technology.

As illustrated in FIG. 3, a beacon parameters field, that is the header of the beacon frame, contains information on a device identifier, a beacon slot number, and device control. In the device control field, b0 indicates whether or not the device is movable. That is, if the device is in a hibernating mode, b0 is set to 0, and if the device is in an active mode, b0 is set to 1.

In the information element fields of a beacon frame, various types of information items can be included with different element IDs. Among them, in a hibernating mode IE (Information Element), information on hibernation countdown and the duration of hibernation is included. The hibernation countdown indicates how many super frames after a current time the device will enter into a hibernating mode. The duration of hibernation indicates for how many super frames the device will be in the hibernating mode.

FIG. 4 is a diagram illustrating a problem of the related technology.

As illustrated in FIG. 4, even when device 8 is in a movable state and can move toward the front, if beacon slots used by devices not in a movable state, i.e., in a hibernating mode, are positioned after the beacon slot of the current device 8, the length of the entire beacon period does not change. This problem occurs because the devices in the hibernating mode do not transmit or receive beacon frames and thus the devices are in a state in which they cannot change a beacon slot.

### SUMMARY OF THE INVENTION

Exemplary embodiments of the present invention provide an apparatus and method by which in a distributed network, before a device which has declared to enter into a hibernating mode enters into a hibernating mode, the beacon slot of the device is moved to the front of the beacon period so that the length of the entire beacon period can be shortened and thus the super frame can be efficiently used.

According to an exemplary aspect of the present invention, there is provided a method of setting a beacon slot by a predetermined device within a distributed wireless network, the method including: determining a partner device with which the predetermined device is to exchange beacon slots in a predetermined super frame in which the predetermined device is to enter into a hibernating mode, among devices using beacon slots positioned prior to the beacon slot of the predetermined device in a current super frame; and changing the beacon slot of the predetermined device based on the determination.

The determining the partner device comprises: before the predetermined super frame begins, determining that the partner device is a device which uses a beacon slot positioned within a current super frame prior to the beacon slots of devices that are capable of recognizing that the predetermined device plans to begin hibernation in the predetermined super frame, and are to be in an active mode in the predetermined super frame.

When determining the partner device, a device which plans to begin hibernation within a predetermined time after the predetermined super frame ends may not be determined as a partner device.

The predetermined time may be a time corresponding to a maximum number of super frames in which the devices in the network are permitted to fail to hear a beacon period.

The distributed wireless network may be a wireless personal area network using an ultra wideband.

According to another exemplary aspect of the present invention, there is provided a computer readable recording medium having embodied thereon a computer program for executing the method of setting a beacon slot.

According to another exemplary aspect of the present invention, there is provided an apparatus for setting a beacon slot by a predetermined device within a distributed wireless network, the apparatus including: a determination unit which determines a partner device with which the predetermined device is to exchange beacon slots in a predetermined super frame in which the predetermined device plans to begin hibernation, wherein the partner device is one of a plurality of devices using beacon slots positioned before the beacon slot of the predetermined device in current super frame; and a changing unit which changes the beacon slot of the predetermined device based on the determination.

According to another exemplary aspect of the present invention, there is provided a method of setting a beacon slot by a predetermined device within a distributed wireless network, the method including: if it is recognized that a third device using a beacon slot positioned after the beacon slot of the predetermined device in a current super frame, plans to begin hibernation from a predetermined super frame, determining whether or not to exchange beacon slots with the third device; and selectively changing the beacon slot of the predetermined device in the super frame, based on the determination.

In determining whether or not to change beacon slot, if the beacon slot being used by the predetermined device is positioned in a current super frame prior to the beacon slots of devices planning to be in an active mode in the predetermined super frame and capable of recognizing the third device plans to begin hibernation from the predetermined super frame before the predetermined super frame begins, it may be determined to exchange beacon slots with the third device.

In determining whether or not to exchange beacon slots with the third device, if the predetermined device plans to begin hibernation within a predetermined time after the predetermined super frame ends, it may be determined not to exchange beacon slots with the third device.

The predetermined time may be a time corresponding to a maximum number of super frames in which the devices in the network are permitted to fail to hear a beacon period.

According to another exemplary aspect of the present invention, there is provided a computer readable recording medium having embodied thereon a computer program for executing the method of setting a beacon slot.

According to another exemplary aspect of the present invention, there is provided an apparatus for setting a beacon slot by a predetermined device within a distributed wireless network, the apparatus including: a determination unit which determines whether or not to exchange beacon slots with a third device that is using a beacon slot positioned after the beacon slot of the predetermined device in a current super frame if it is recognized that the third device plans to begin hibernation from a predetermined super frame; and a changing unit which selectively changes the beacon slot of the predetermined device in the hibernation planned super frame, based on the determination.

### BRIEF DESCRIPTION OF THE DRAWINGS

The above and other exemplary aspects of the present invention will become more apparent by the following detailed description of exemplary embodiments thereof with reference to the attached drawings in which:

FIG. 1 is a diagram illustrating a structure of a super frame used in a distributed wireless network according to related technology;

FIG. 2 is a diagram illustrating a method of shortening the length of a beacon period according to related technology;

FIG. 3 is a diagram illustrating a structure of a beacon frame used in a multiband orthogonal frequency division multiplexing alliance media access control (MBOA-MAC) according to related technology;

FIG. 4 is a diagram illustrating a problem of changing a beacon slot according to related technology;

FIG. 5 is a flowchart illustrating a process of changing a beacon slot of a device before the device enters into a hibernation mode according to an exemplary embodiment of the present invention.

FIG. 6 is a flowchart illustrating a process in which a current device setting a beacon slot determines a partner device with which the current device is to exchange beacon slots before entering into a hibernation mode according to an exemplary embodiment of the present invention;

FIG. 7 is a flowchart illustrating a process in which a device setting a beacon slot determines whether or not to change a beacon slot according to an exemplary embodiment of the present invention;

FIG. 8 is a flowchart illustrating a process in which a device setting a beacon slot determines whether or not to exchange beacon slots with another device, which has declared that it will enter into a hibernation mode, according to an exemplary embodiment of the present invention;

FIGS. 9A through 9D are diagrams illustrating a method of setting a beacon slot according to an exemplary embodiment of the present invention;

FIG. 10 is a diagram illustrating methods of setting a beacon slot according to other exemplary embodiments of the present invention; and

FIG. 11 is a diagram illustrating a structure of an apparatus for setting a beacon slot according to an exemplary embodiment of the present invention.

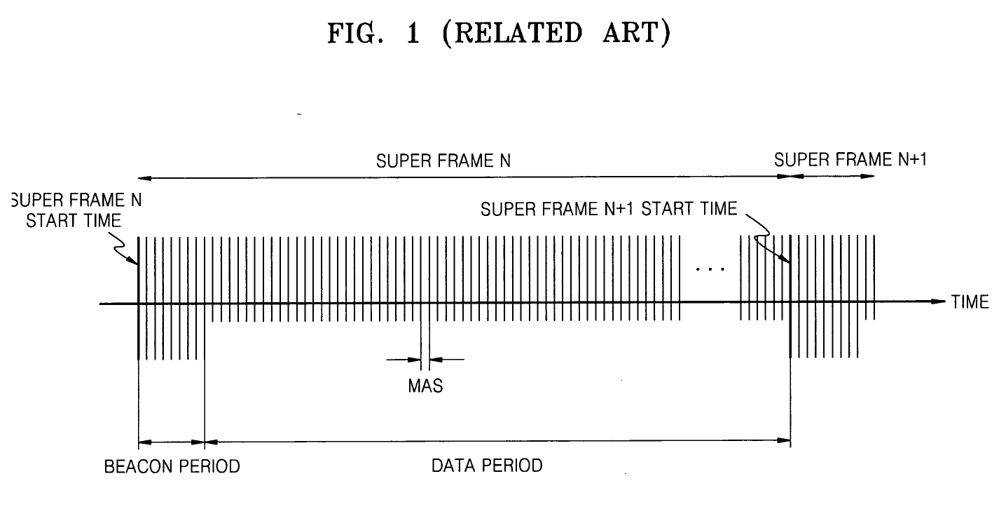

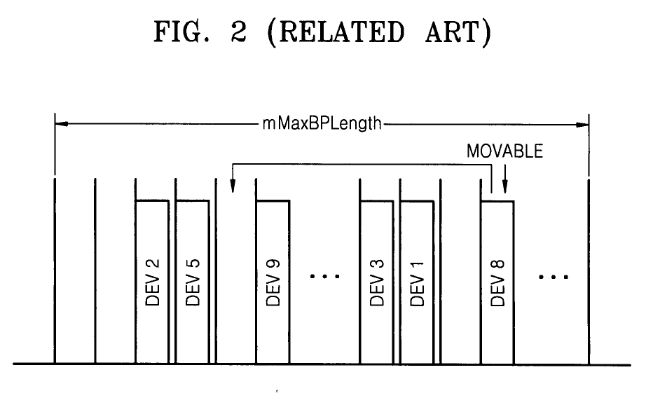

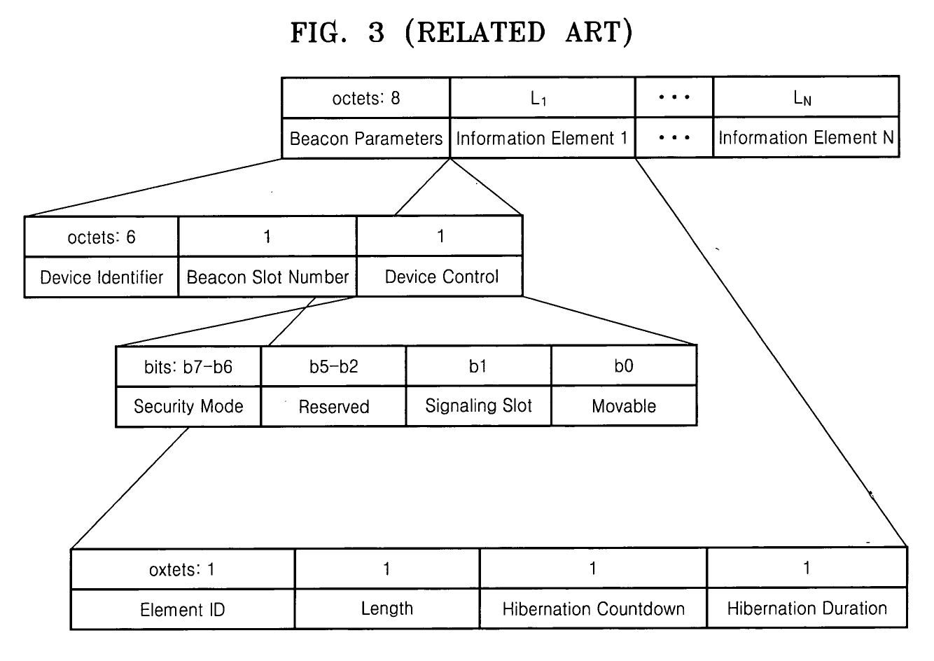

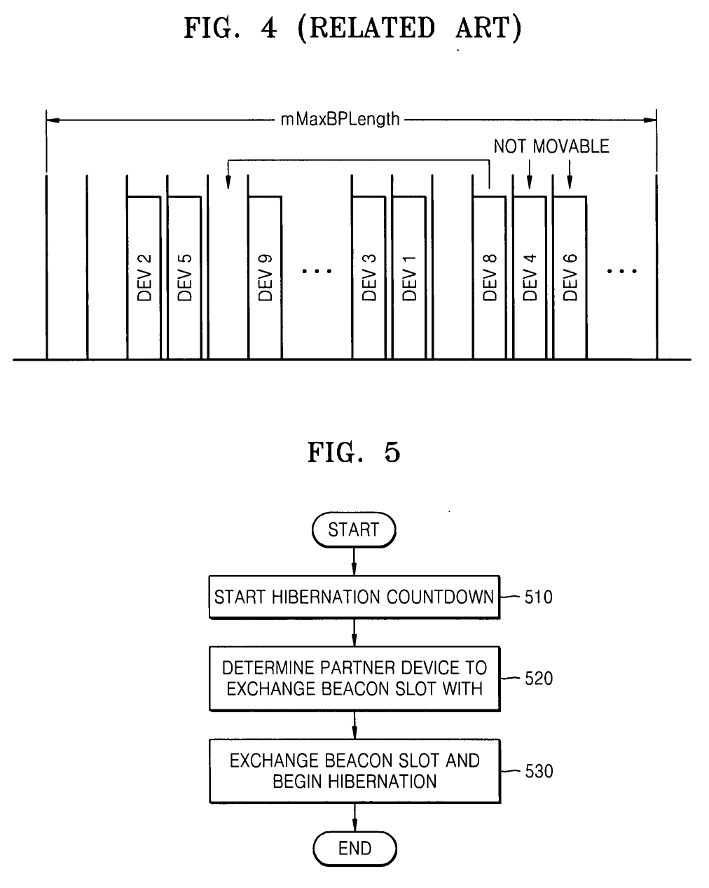

### DETAILED DESCRIPTION OF EXEMPLARY EMBODIMENTS OF THE INVENTION

The present invention will now be described more fully with reference to the accompanying drawings, in which exemplary embodiments of the invention are shown.

FIG. 5 is a flowchart illustrating a process of changing a beacon slot of a device before the device enters into a hibernation mode according to an exemplary embodiment of the present invention.

In operation 510, the device determines that it will enter into a hibernating mode, sets an appropriate value in a hibernation countdown field, and begins hibernation countdown.

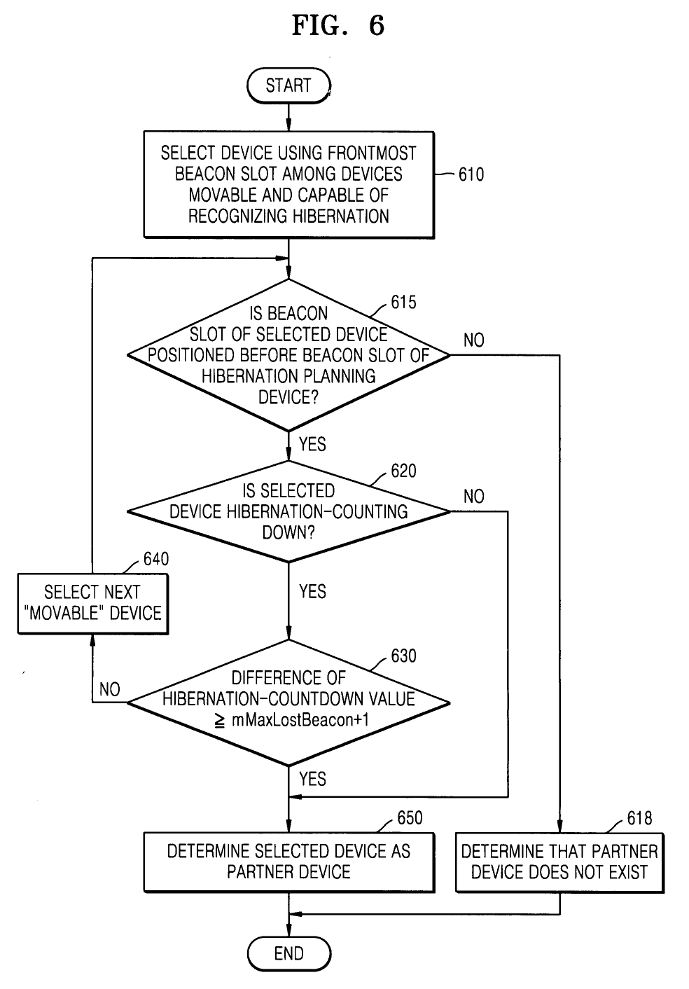

In operation 520, the device which has determined to enter into a hibernating mode (hereinafter referred to as a ‘hibernation planning device’) determines a device (hereinafter referred to as a ‘partner device’) with which the hibernation planning device will exchange beacon slots, before the hibernation planning device enters into a hibernating mode. A method of determining the partner device will be explained later in more detail with reference to FIG. 6.

In operation 530, the hibernation planning device enters into a hibernating mode from a super frame just after a super frame in which the hibernation countdown field value of the beacon frame of the device is 0. Also, the device changes its beacon slot into the beacon slot of the partner device determined in operation 520. Here, the partner device also changes its beacon slot into the beacon slot of the hibernation planning device. Operation 520 will be explained in more detail below with reference to FIG. 6.

FIG. 6 is a flowchart illustrating a process in which a hibernation planning device determines a partner device with which the hibernation planning device is to exchange beacon slots before the hibernation planning device enters into a hibernating mode.

In operation 610, the hibernation planning device can recognize a predetermined super frame (hereinafter referred to as a ‘hibernation planned super frame’), and selects a device which uses a beacon slot positioned frontmost (closest to the beginning) among movable devices in the hibernation planned super frame.

Since the selected device should recognize the hibernation countdown field value included in the beacon frame of the hibernation planning device before the hibernation planning device enters into a hibernating mode, the selected device should be in an active mode for at least mMaxLostBeacon+1 continuous super frames before the hibernation planned super frame. Here, mMaxLostBeacon means a maximum number of super frames that devices in the distributed wireless network are permitted not to listen to the beacon periods.

In operation 615, the hibernation planning device determines whether or not the beacon slot used by the selected device is positioned before the beacon slot of the hibernation planning device in a current beacon period. If the beacon slot of the selected device is not positioned before the beacon slot of the hibernation planning device, the hibernation planning device determines that no partner device exists. This is because changing the beacon slot of the hibernation planning device to the back of the current position is meaningless in light of the purpose of the present invention.

In operation 620, if the beacon slot of the selected device is positioned before the beacon slot of the hibernation planning device in the current beacon period, it is determined whether or not the selected device is hibernation-counting down. In operation 650, if the selected device is not hibernation-counting down, the selected device is determined as a partner device.

In operation 630, if the selected device is hibernation-counting down, it is determined whether or not the difference between the hibernation-countdown value of the hibernation planning device and that of the selected device, i.e., the difference between the hibernation countdown field values of the beacon frames, is equal to or greater than mMaxLostBeacon+1. If the difference of the hibernation countdown values is equal to or greater than mMaxLostBeacon+1, the selected device is determined as a partner device, or else in operation 640 a next movable device is selected and then, operation 615 is performed.

The comparison of the difference between the hibernation countdown values of the selected device and the hibernation planning devices is to avoid exchange of beacon slots with a device which will enter into a hibernating mode in a short time after exchanging beacon slots.

Here, the short time indicates mMaxLostBeacon. After the hibernation countdown value becomes 0, the hibernation planning device enters into a hibernating mode and at the same time exchanges beacon slots. Accordingly, for example, if the difference between the hibernation countdown values is mMaxLostBeacon, the hibernation countdown value of the selected device is mMaxLostBeacon−1 in the hibernation planned super frame.

Accordingly, even though the selected device changes the beacon slot, until before hibernation, that is, until the hibernation countdown value of the selected device becomes 0, mMaxLostBeacon super frames are remaining, and thus devices that do not listen mMaxLostBeacon super frames may not be able to recognize that the selected device will enter into a hibernating mode. In this case, a risk that the selected device may onesidedly change a beacon slot occurs. Accordingly, after the selected device exchanges beacon slots and before the selected device enters into a hibernating mode, only when there is a time enough to exchange beacon slots again, the selected device is determined as a partner device.

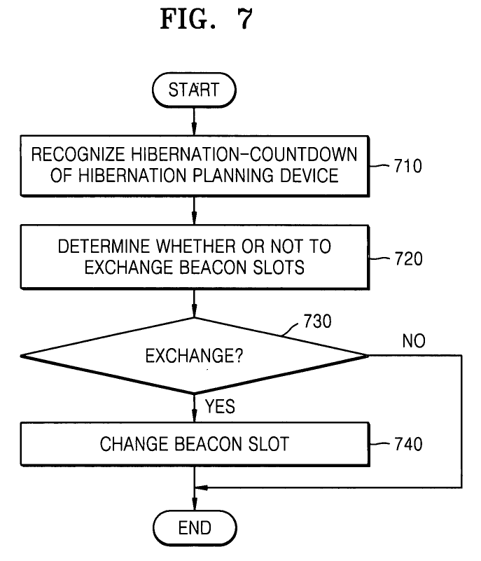

FIG. 7 is a flowchart illustrating a process in which a device (hereinafter referred to as a ‘candidate device’) in a distributed wireless network changes a beacon slot according to an exemplary embodiment of the present invention. All devices belonging to the distributed wireless network will perform operations as follows.

That is, all device of the distributed wireless network may be candidate devices.

In operation 710, a candidate device receives the beacon frame of a hibernation planning device and thus recognizes that the hibernation planning device will enter into a hibernating mode from a hibernation planned super frame.

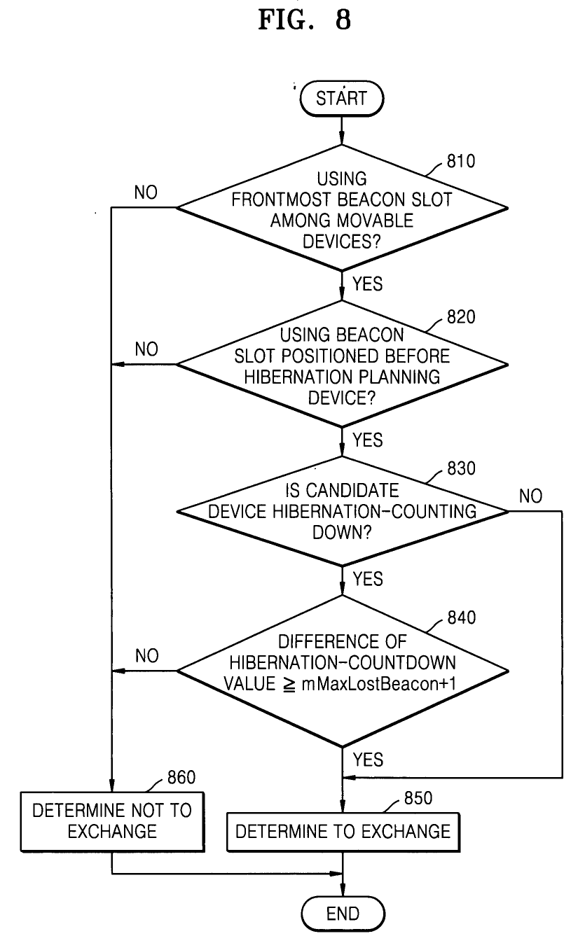

In operations 720 and 730, the candidate device determines whether or not to exchange beacon slots with the hibernation planning device. That is, in operations 720 and 730, the candidate device determines whether or not the candidate device qualifies as a partner device which will exchange beacon slots with the hibernation planning device. This process will be explained in more detail below with reference to FIG. 8.

According to the determination result of operation 720, if it is determined to exchange beacon slots, the candidate device changes the position of its beacon slot in the hibernation planned super frame in operation 740.

FIG. 8 is a flowchart illustrating a process in which a candidate device determines whether or not to exchange beacon slots with a hibernation planning device according to an exemplary embodiment of the present invention.

In operation 810, the candidate device determines whether or not its beacon slot is positioned at the frontmost part of the current beacon period among movable devices, and if the beacon slot is not at the frontmost part, the candidate device determines not to exchange beacon slots in operation 860. If the beacon slot is positioned at the frontmost part, operation 820 is performed.

In operation 820, the candidate device determines whether or not its beacon slot is positioned before the beacon slot of a hibernation planning device in the current beacon period, and if the beacon slot of the candidate device is not before the beacon slot of the hibernation planning device, the candidate device determines not to exchange beacon slots in operation 860. If the beacon slot of the candidate device is before the beacon slot of the hibernation planning device, operation 830 is performed.

In operation 830, the candidate device determines whether or not the candidate device is hibernation-counting down, and if so, operation 840 is performed. If the candidate device is not hibernation-counting down, the candidate device determines to exchange beacon slots in operation 850.

In operation 840, the candidate device determines whether or not the difference between the hibernation countdown values of the candidate device and the hibernation planning device is equal to or greater than mMaxLostBeacon+1, and if the difference is not equal to or greater than mMaxLostBeacon+1, the candidate device determines not to exchange beacon slots in operation 860. If the difference is equal to or greater than mMaxLostBeacon+1, the candidate device determines to exchange beacon slots in operation 850.

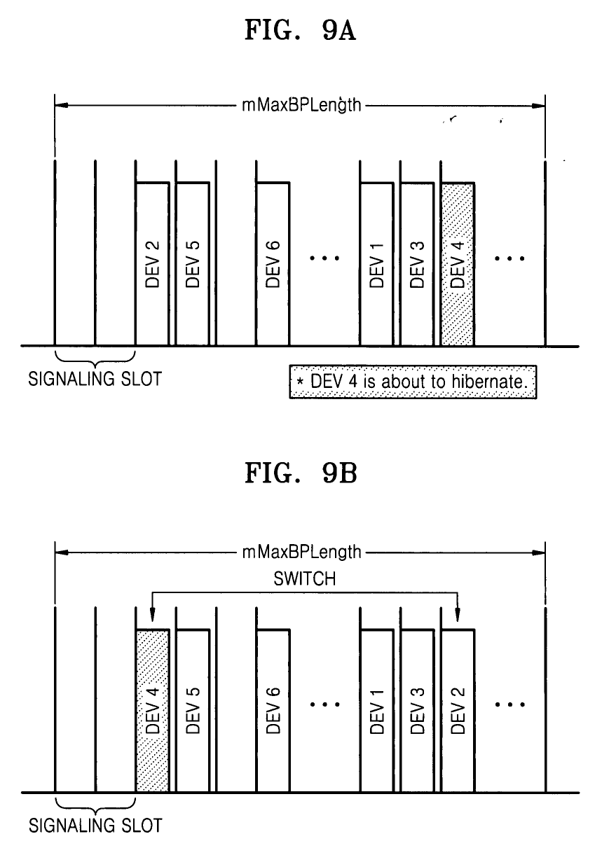

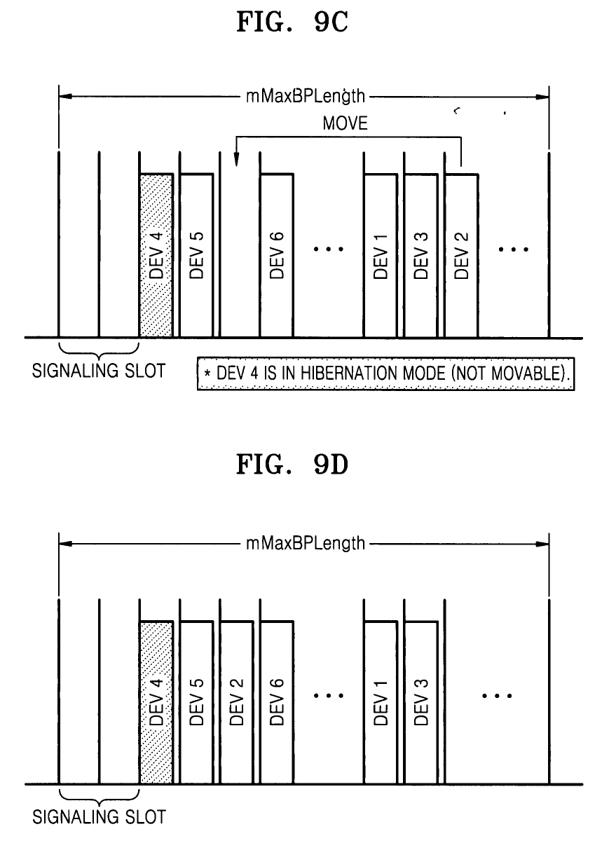

FIGS. 9A through 9D are diagrams illustrating a method of setting a beacon slot according to an exemplary embodiment of the present invention.

Referring FIG. 9A, device 4 is hibernation-counting down, and the remaining devices recognize this through the beacon frame of device 4. Accordingly, device 4 exchanges beacon slots with device 2 which uses a beacon slot positioned at the frontmost part of the beacon period among the devices in an active mode. The beacon period after the beacon slots are exchanged is illustrated in FIG. 9B.

After the beacon slot of device 4 that is a hibernation planning device is moved to the front through the process illustrated in FIGS. 9A and 9B according to the current embodiment of the present invention, a beacon slot changing method according to the related art technology is applied as illustrated in FIGS. 9C and 9D. That is, as illustrated in FIGS. 9C and 9D, device 2 which has exchanged beacon slots with device 4 sets an empty beacon slot positioned before the beacon slot of device 2, as its beacon slot. Accordingly, the resulting structure is as illustrated in FIG. 9D. Through a series of these processes, the length of the beacon period is shortened and thus the super frame can be efficiently used.

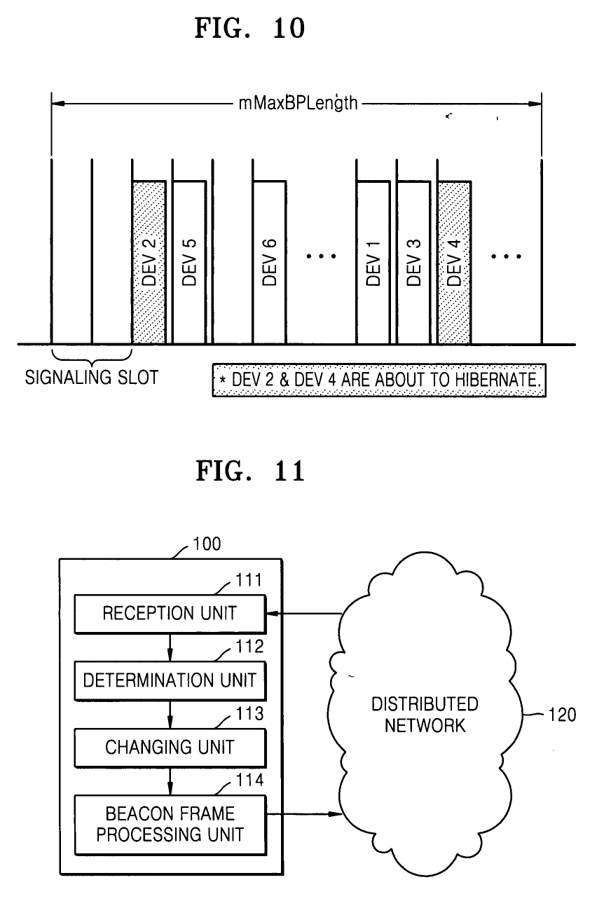

FIG. 10 is a diagram illustrating methods of setting a beacon slot according to other exemplary embodiments, the second and third exemplary embodiments, of the present invention.

As illustrated in FIG. 10, the second and third embodiments relate to a case where device 4 which is a hibernation planning device is searching for a partner device, while device 2 which uses a beacon slot positioned at the frontmost part of the beacon period is hibernation-counting down.

First, in the second exemplary embodiment, it is assumed that the difference between the hibernation countdown values of device 2 and device 4 is equal to or greater than mMaxLostBeacon+1. More specifically, it is assumed that mMaxLostBeacon=3, the hibernation countdown value of device 2 is 8, and the hibernation countdown value of device 4 is 4.

In this case, in the hibernation planned super frame in which device 4 enters into a hibernating mode, the hibernation countdown value of device 2 becomes 3. This means that even after device 2 exchanges beacon slots with device 4, device 2 can clearly inform other devices of its hibernation plan during a period of 4 super frames (the super frames until the hibernation countdown value of device 4 becomes 0), and thus device 2 can have a time enough to exchange beacon slots with another device before device 2 enters into a hibernating mode.

Accordingly, according to the second embodiment, device 2 exchanges beacon slots with device 4 in the hibernation planned super frame. Also, after that time, processes illustrated in FIGS. 9C and 9D will be performed, and explanation of this will be omitted here.

Meanwhile, in the third exemplary embodiment, it is assumed that the difference between the hibernation countdown values of device 2 and device 4 is less than mMaxLostBeacon+1. More specifically, it is assumed that mMaxLostBeacon=3, the hibernation countdown value of device 2 is 7, and the hibernation countdown value of device 4 is 4.

In this case, in the hibernation planned super frame in which device 4 enters into a hibernating mode, the hibernation countdown value of device 2 becomes 3. This means that even if device 2 exchanges beacon slots with device 4, device 2 can broadcast its hibernation plan to other devices during a period of 3 super frames (the super frames until the hibernation countdown value of device 4 becomes 0). In this network, the devices are permitted not to listen to a beacon frame up to three times and device 2 may not recognize the hibernation plan of device 4. Accordingly, since device 4 should not regard device 2 as a partner device, the beacon slots of device 2 and device 4 are not exchanged.

FIG. 11 is a diagram illustrating a structure of an apparatus for setting a beacon slot according to an exemplary embodiment of the present invention. As illustrated in FIG. 11, the apparatus for setting a beacon slot according to the current embodiment is composed of a reception unit 111, a determination unit 112, a changing unit 113, and a beacon frame processing unit 114. This apparatus is implemented in each device 100 disposed in a distributed network 120.

The reception unit 111 identifies information of devices by receiving beacon frames of the devices in the distributed wireless network 120.

The determination unit 112 determines a partner device by analyzing the received beacon frames if the device 100 plans to enter into a hibernating mode.

If the device 100 works as a candidate device, the determination unit 112 determines whether or not to exchange beacon slots with a hibernation planning device. Explanations of these determination processes are provided above in detail and will be omitted here.

The changing unit 113 selectively changes a beacon slot based on the determination in the determination unit 112. If the device 100 operates as a hibernation planning device, the changing unit 113 exchanges beacon slots with a partner device in a hibernation planned super frame. If the device 100 operates as a partner device, the changing unit 113 exchanges beacon slots with a hibernation planning device.

According to the exemplary embodiments of the present invention, the beacon slot of a device planning to enter into a hibernating mode is moved to the front before the device enters into a hibernating mode such that beacon slots of devices in a hibernating mode can be prevented from being positioned at the back part of a beacon period. Accordingly, the entire length of the beacon period can be ultimately shortened and thus the length of the data transmission period is lengthened and the super frame can be efficiently used.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of setting a beacon slot by a predetermined device within a distributed wireless network, the method comprising:
determining a partner device with which the predetermined device is to exchange beacon slots in a predetermined super frame in which the predetermined device is to enter into a hibernating mode, among devices using beacon slots positioned prior to the beacon slot of the predetermined device in a current super frame; and
changing the beacon slot of the predetermined device based on the determination.

2. The method of claim 1, wherein the determining of the partner device, comprises:
before the predetermined super frame begins, determining that the partner device is a device which uses a beacon slot positioned within the current super frame prior to the beacon slots of devices that are capable of recognizing that the predetermined device plans to begin hibernation in the predetermined super frame and are to be in an active mode in the predetermined super frame.

3. The method of claim 2, wherein no device which plans to begin hibernation within a predetermined time after the predetermined super frame ends is determined as a partner device.

4. The method of claim 3, wherein the predetermined time corresponds to a maximum number of super frames in which the devices in the network are permitted to fail to hear a beacon period.

5. The method of claim 1, wherein the distributed wireless network is a wireless personal area network using an ultra wideband.

6. A computer readable recording medium having embodied thereon a computer program for executing the method of claim 1.

7. An apparatus for setting a beacon slot by a predetermined device in a distributed wireless network, the apparatus comprising:
a determination unit which determines a partner device with which the predetermined device is to exchange beacon slots in a predetermined super frame in which the predetermined device plans to begin hibernation, wherein the partner device is one of a plurality of devices using beacon slots positioned prior to the beacon slot of the predetermined device in a current super frame; and
a changing unit which changes the beacon slot of the predetermined device based on the determination.

8. The apparatus of claim 7, wherein the a partner device uses a beacon slot positioned prior to the beacon slots of a plurality of devices that are capable of recognizing that the predetermined device plans to begin hibernation in the predetermined super frame, before the predetermined super frame begins, and are to be in an active mode in the predetermined super frame.

9. The apparatus of claim 8, wherein the determination unit determines that a device which plans to begin hibernation within a predetermined time after the predetermined super frame ends is not determined as a partner device.

10. The apparatus of claim 9, wherein the predetermined time is a time corresponding to a maximum number of super frames in which the devices in the network are permitted not to hear a beacon period.

11. The apparatus of claim 7, wherein the distributed wireless network is a wireless personal area network using an ultra wideband.

12. A method of setting a beacon slot by a predetermined device of a distributed wireless network, the method comprising:
if it is recognized that a third device, using a beacon slot positioned after the beacon slot of the predetermined device in a current super frame, plans to begin hibernation from a predetermined super frame, determining whether or not to exchange beacon slots with the third device; and
selectively changing the beacon slot of the predetermined device in the super frame, based on the determination.

13. The method of claim 12, wherein determining of whether or not to exchange beacon slots, comprises:
if the beacon slot, being used by the predetermined device positioned in the current super frame prior to the beacon slots of devices planning to be in an active mode in the predetermined super frame and capable of recognizing the third device, plans to begin hibernation from the predetermined super frame before the predetermined super frame begins, determining to exchange beacon slots with the third device.

14. The method of claim 13, wherein determining of whether or not to exchange beacon slots with the third device, comprises
if the predetermined device plans to begin hibernation within a predetermined time after the predetermined super frame ends, determining not to exchange beacon slots with the third device.

15. The method of claim 14, wherein the predetermined time is a time corresponding to a maximum number of super frames in which the devices in the network are permitted to fail to hear a beacon period.

16. The method of claim 12, wherein the distributed wireless network is a wireless personal area network using an ultra wideband.

17. A computer readable recording medium having embodied thereon a computer program for executing the method of claim 12.

18. An apparatus for setting a beacon slot by a predetermined device of a distributed wireless network, the apparatus comprising:
a determination unit which determines whether or not to exchange beacon slots with a third device if it is recognized that the third device plans to begin hibernation from a predetermined super frame, wherein the third device uses a beacon slot positioned prior to a beacon slot of the predetermined device in the a current super frame; and
a changing unit which selectively changes the beacon slot of the predetermined device in the hibernation planned super frame, based on the determination by the determination unit.

19. The apparatus of claim 18, wherein if the beacon slot, being used by the predetermined device is positioned in current super frame prior to the beacon slots of devices planning to be in an active mode in the predetermined super frame and capable of recognizing the third device, plans to begin hibernation from the predetermined super frame before the predetermined super frame begins, the determination unit determines to exchange beacon slots with the third device.

20. The apparatus of claim 19, wherein if the predetermined device plans to begin hibernation within a predetermined time after the predetermined super frame ends, the determination unit determines not to exchange beacon slots with the third device.

21. The apparatus of claim 19, wherein the predetermined time corresponds to a maximum number of super frames in which the devices in the network are permitted to fail to hear a beacon period.

22. The apparatus of claim 18, wherein the distributed wireless network is a wireless personal area network using an ultra wideband.
